(19) United States
(12) Patent Application Publication
(10) Pub. No.: US 2009/0293111 A1
(43) Pub. Date: Nov. 26, 2009

(54) THIRD PARTY SYSTEM FOR BIOMETRIC AUTHENTICATION

(76) Inventors: Yau S. Lai, Orlando, FL (US); Rodney P. Meli, Lake Mary, FL (US); Stephen J. Nation, Apopka, FL (US); Ron L. Nation, Longwood, FL (US); Ann W. Shaffer, Longwood, FL (US)

Correspondence Address: FOLEY & LARDNER LLP, 150 EAST GILMAN STREET, P.O. BOX 1497, MADISON, WI, 53701-1497, US

(21) Appl. No.: 12/472,232

(22) Filed: May 26, 2009

Related U.S. Application Data
(63) Continuation of application No. 12/472,122, filed on May 26, 2009.
Application No. 12/472,122 is a continuation-in-part of application No. 11/564,655, filed on Nov. 29, 2006.
(60) Provisional application No. 60/740,569, filed on Nov. 29, 2005.

(51) Int. Cl. H04L 9/32; G06F 21/00

(52) U.S. Cl. 726/6; 713/186; 726/5; 726/7

(57) ABSTRACT

A method of authenticating an identity of a user includes launching a user interface and obtaining biometric data of a user at the user interface. The method further includes comparing the biometric data of the user to stored biometric information of the user that was previously obtained during an enrollment process. A comparison result is generated and provided to a third party system documenting if the stored biometric information was satisfied, wherein the third party system is configured to utilize the comparison result to authenticate an identity of the user

### CROSS REFERENCE TO RELATED APPLICATIONS

This application is a continuation of U.S. patent application Ser. No. ______ (Attorney Docket No. 092245-0104) filed ______ and entitled “SERVER-SIDE BIOMETRIC AUTHENTICATION”, which is a continuation in part of U.S. patent application Ser. No. 11/564,655, filed Nov. 29, 2006, and entitled “SYSTEM AND METHOD FOR DATA SOURCE AUTHENTICATION AND PROTECTION SYSTEM USING BIOMETRICS FOR OPENLY EXCHANGED COMPUTER FILES” which claims the benefit of U.S. Provisional Application No. 60/740,569 filed Nov. 29, 2005.

### FIELD

The present disclosure relates to electronic commerce. More specifically, the present disclosure relates to a user authentication and protection system using biometrics.

### BACKGROUND

Electronic commerce has become an increasingly efficient and profitable way of conducting business. In a number of applications, electronic commerce has involved the access of information that, if compromised, could create substantial adverse financial, social, or personal issues for the parties. One example of such electronic business is online banking wherein a user may access a bank account and the corresponding funds online. If an unauthorized person were to gain access to an online bank account, the unauthorized person could possibly freely dispense the funds within the account. Accordingly, what is needed is a system and method for securely and confidently ensuring the identification of a user.

### SUMMARY

An embodiment relates to a system and method for authenticating the identity of a user or delegate of the user, specifically with the use of biometric data. The identity of the user may be verified using a combination of a username, a secret password, and the user's biometric identifier. The embodiment uses fingerprint matching technology or other biometric information to implement the biometric identification system. The user authentication is performed at a secure server that is connected to a client application at a client computer and to a third party system over a communication network.

The embodiment provides a mechanism by which a third party system and a user may implement a biometric authentication process as disclosed throughout the specification. A user interface such as a client application is installed on a client computer which may be used to perform login functionality and communication with a biometric peripheral. The user interface is associated with a third party system that utilizes the user authentication by the server to verify the identity of the user. The client application may also be used to perform the tasks of user registration and biometric data enrollment of a user. The client application is in secure communication with a secure server which is connected to a secure database. The third party system is also communicatively connected to the client application and the secure server.

The embodiment provides multiple layers of security in all sensitive areas. Authentication of user account credential information and biometric data is performed at the server so that the account credential information and biometric data of the user need not be stored at a client computer. In this way system security is enhanced because a malicious entity may not access the account credential information or biometric data at a client computer. The processes and procedures which have been defined for registration and enrollment help ensure that biometric identification credentials of users cannot be falsified. These processes and procedures work together with layers of software security technology to ensure the integrity of the information being protected. The software technology used to implement the layers of protection may include secure communication between the client applications and the server, layered encryption, proprietary encryption key management, insertion of blocks of seemingly random data, information obfuscation, digital signature generation, and encryption based application security.

### BRIEF DESCRIPTION OF THE DRAWINGS

The accompanying drawings, which are included to provide a further understanding of described embodiments.

FIG. 1 illustrates an operational environment according to a representative embodiment.

FIG. 2 illustrates a server-side biometric authentication process according to a representative embodiment.

FIG. 3 illustrates a third party system operational environment according to a representative embodiment.

FIG. 4 illustrates user registration according to a representative embodiment.

FIG. 5 illustrates user registration according to an alternative representative embodiment.

FIG. 6 illustrates user enrollment according to a representative embodiment.

FIG. 7 illustrates operations performed in a login process according to a representative embodiment.

FIG. 8 illustrates operations performed in a process whereby a user or registrar login using biometric information according to a representative embodiment.

FIG. 9 illustrates operations performed in a process of capturing biometric data such as a user's fingerprint template according to a representative embodiment.

FIG. 10 illustrates operations performed in a process of recording a user's fingerprint template according to a representative embodiment.

FIG. 11 illustrates operations performed in a login process for a third party system according to a representative embodiment.

### DETAILED DESCRIPTION

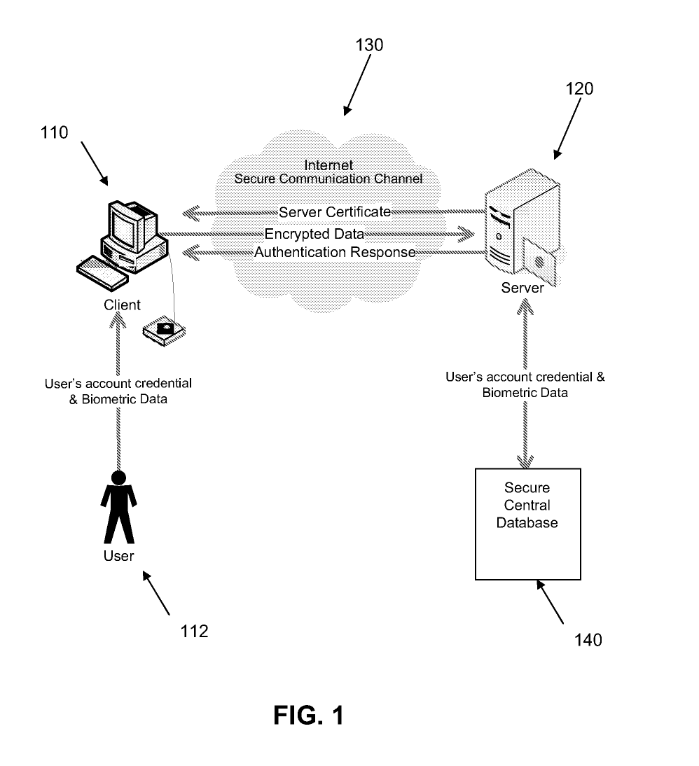

FIG. 1 illustrates an operational environment for authentication of the identity of a user at a secure server according to an embodiment. A client computer 110 is in communication with a server 120 over a network 130 such as the Internet. In an embodiment, client computer 110 is a Microsoft Windows based workstation with high speed internet connections. In alternative embodiments, client compute 110 may utilize any operating system known to those of skill in the art. Client computer 110 uses a compatible fingerprint sensor (or other suitable biometric sensor) which captures biometric information from a user 112. In an embodiment, client computer 110 includes a client application which may be downloaded from a network such as the Internet and installed on client computer 110. In alternative embodiments, the client application may be installed on the workstation via any method known by those of skill in the art. The client application may be used to collect the biometric information from user 112 and may handle communications between client computer 110 and server 120.

Client computer 110 is configured to communicate encrypted data over network 130 via a secure channel to server 120. In an embodiment, prior to communication of the encrypted data, client computer 110 requests and receives from server 120 a server certificate to verify the server's authenticity. Client computer 110, via the client application, generates an encrypted identification record based on the user's captured biometric information and the user's account credential information such as a unique username and password submitted by the user. In an alternative embodiment, the encrypted information record may include data related only to the captured biometric information or only the user's account credential information such as the username and password. Client computer 110, via the client application, then transmits the encrypted identification record to server 120 for authentication processing. In an embodiment, secure transmission channels are used for transmitting the encrypted identification record.

Server 120 is coupled to a database 140 which stores previously submitted account credentials and biometric data. Server 120 receives and decrypts the encrypted information record transmitted from client computer 110. Utilizing the data in the encrypted (now decrypted) information record, server 120 compares the captured biometric information of user 112 and/or the account credential information from user 112 (i.e., the unique username and password) with the previously submitted account credentials and biometric data stored in database 140. If the captured biometric information and account credentials successfully match the previously submitted account credentials and biometric data, server 120 authenticates user 112. Server 120 communicates an authentication response verifying or denying the submitted biometric data and account credentials to client computer 110 over network 130 via a secure channel. As such, server 120 performs all authentication services at a secure location thus preventing possible tampering with the authentication process at a corresponding client computer.

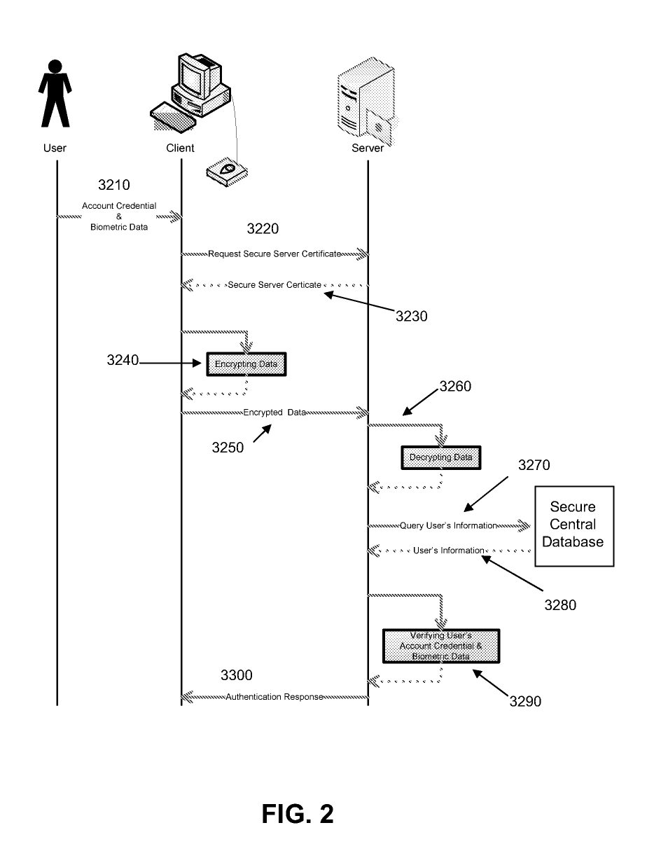

FIG. 2 illustrates operations performed in a server-side biometric authentication process during user login to a secured account after a user has been successfully registered and enrolled as described below or registered and enrolled by another process known to those of skill in the art. Additional, fewer, or different operations may be performed depending on the implementation. In an operation 3210, a client computer receives an account credential and/or biometric data from a user. In an embodiment, the client computer includes a client application as discussed above. The account credential and biometric data can be obtained in a variety of ways, as described below. The account credential may include the user's username and password or other identifying information.

In an operation 3220, the client computer, via the client application, requests a secure server certificate from a server to verify the authenticity of the server. In an operation 3230, the server provides the certificate to the client computer thereby proving the authenticity of the server. Upon receipt of the certificate, the client application generates an encrypted binary information record that includes the user's submitted biometric data and the user's account credential information such as the user's username and password or other identifying information in an operation 3240. In an alternative embodiment, the encrypted information record may include only the user's username and password or only the user's submitted biometric data. The encrypted data is communicated to the server from the client computer in an operation 3250. In an embodiment, communications between the client computer and the server are accomplished over secure channels. The encrypted data is received and decrypted at the server in an operation 3260 and stored in a database.

When an authentication procedure is invoked, a query of user's information is made of the database by the server in an operation 3270. The database provides user information to the server for verification purposes in an operation 3280. As such, the database may provide the biometric data and account credential information submitted by the user during registration and enrollment processes. In an operation 3290, the server verifies the user's submitted account credentials (i.e., username, password, or other identifying information) and/or biometric data by comparing it to the stored information received from the database. This verification is done at the server. In an operation 3300, an authentication response is communicated from the server to the client computer. The authentication response includes an indication of whether the user's submitted account credentials and biometric data were successfully authenticated. In this way, the user's biometric data is not stored on the client computer. As such, it is impossible to compromise security due to unauthorized individuals gaining access at the client computer.

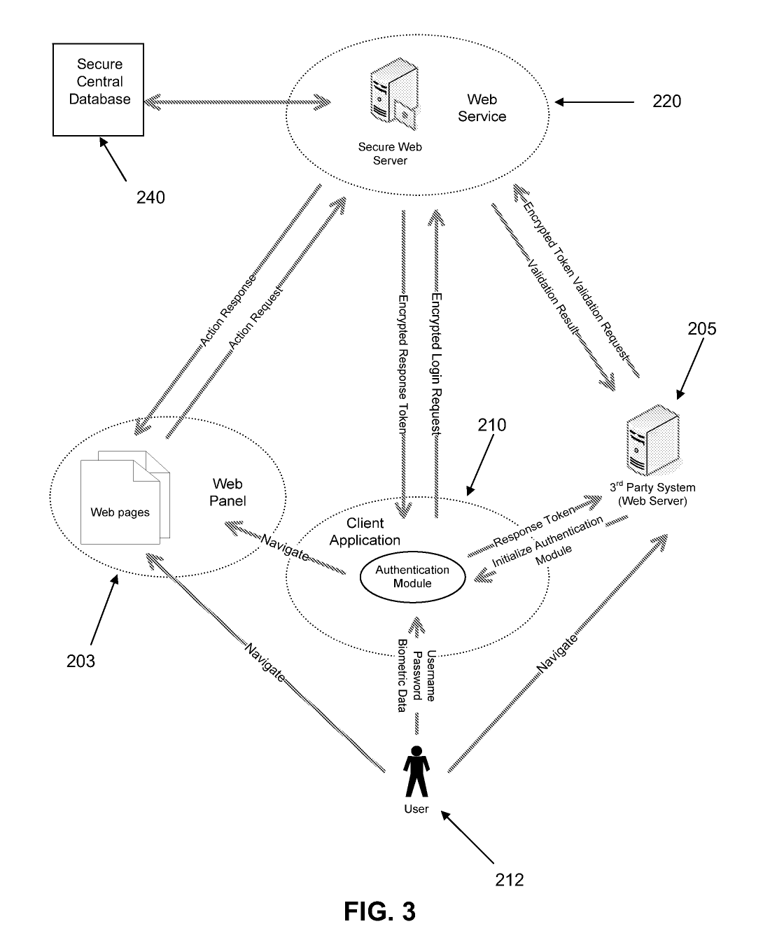

FIG. 3 illustrates an embodiment of a third party system configuration. A web panel 203 is accessible to a user 212 across a network. Web panel 203 is a secure website which may contain a set of web pages and applications which provide a user interface and functionality to perform operations to a user's account associated with a third party system. Web panel 203 allows user 212 to register and enroll the user's biometric data as described below. User 212 may independently navigate to web panel 203 or web panel 203 may be accessed through a third party system 205. Third party system 205 may be any type of system or service which incorporates biometric authentication or other authentication requirements into its login and user identification procedures. In an embodiment, third party system 205 includes a web site controlled by a server that is accessible to user 212 over a network such as the Internet. 100261 Third party system 205 may initialize a client application 210 which can be downloaded by the user's personal computer. In an alternative embodiment, client application 210 may be initialized by and downloaded from web panel 203. After installation on a user's computer, client application 210 handles communications between user 212, third party system 205, and a web service 220. In addition, user 212 may navigate from client application 210 to web panel 203 to perform various operations to the user's account. Encrypted transmissions may be used to enhance the security of these communications. Client application 210 may be used to facilitate registration and biometric data enrollment processes as described below. Client application 210 includes a user interface such as an authentication module. After user 212 has been registered and the user's biometric data has been enrolled, the authentication module may be utilized to login user 212 and to verify the user's biometric data. The authentication module performs the login functionality and the communication with a biometric peripheral, thus allowing login of user 212 and submission of the user's biometric data. The login function and biometric data verification is used by third party system 205 to authenticate the user's identity. In a representative embodiment, the authentication module and client application 210 communicate with web server 220, allowing authentication of the user's identity to be performed at web service 220.

Web panel 203 may also be accessed from client application 210 or, alternatively, web panel 203 may be accessed independently via a secure website supporting web panel 203. Web panel 203 may additionally allow user 212 to assign delegates as described below, view accountability reports, and update the user's profile information. Accountability reports contain login information of user 212 or any assigned delegates. In order to enhance security, information may be transmitted over a secure channel to web service 220 and the information may be encrypted.

Web service 220 is communicatively connected to third party system 205, client application 210, and web panel 203. Web service 220 contains a secure web server. Web service 220 provides user verification services such as an authentication process by which a user's login data is compared to data stored in a database 240 in order to verify the user's identity at login. Web service 220 may also provide user and delegate management functions by which a user's delegates may be managed and secure database management by which database 240 may be managed. Additional, fewer, or different functions may also be performed by web service 220. Web service 220 is communicatively connected to database 240. Database 240 stores various forms of information needed in the biometric authentication process which is accessed by web service 220. This information may include user registration information such as usernames and passwords, user biometric information, user profile information, delegate information, security information, transaction IDs, or any other type of information that may be needed during the biometric authentication process.

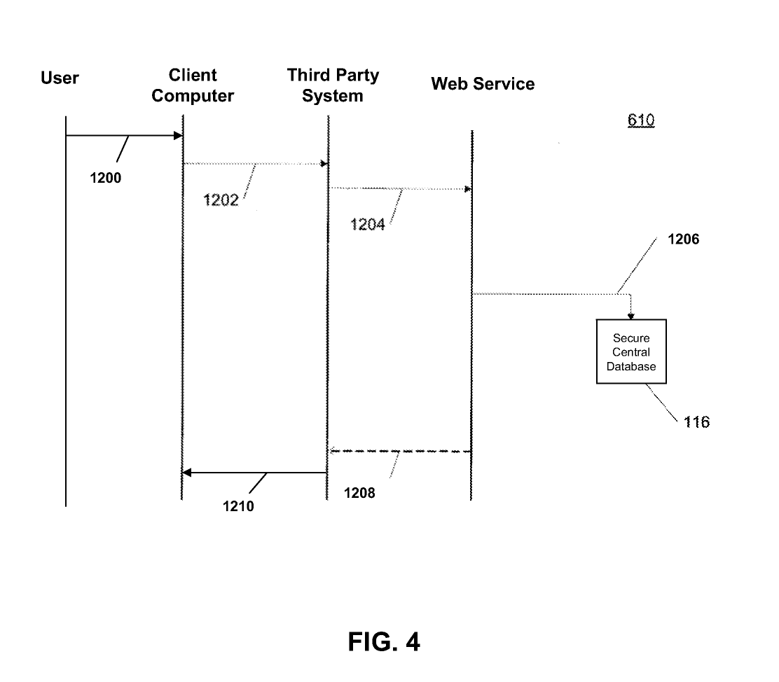

FIG. 4 through FIG. 11 illustrate operations performed in example processes involved in the registration and enrollment of a user according to an embodiment of the system of FIG. 3. These processes are described in detail below. As described in the Summary above, a “user” is a person who is authorized to access a restricted system or account, e.g., a user might be an online account holder as described in the Background above. For a user to be authorized upon submission of his or her biometric data, he or she must be registered as an authorized user. Once registered, the user can then create an account which may be accessed in the future by submitting biometric data.

### Registration

In order to become an active user and open a secure account according to an illustrative embodiment, a user must be registered and enrolled. Once the user has opened a secure account a delegate may be assigned by the user. The first step towards becoming an active user is the user registration process, illustrated in FIG. 4. In an embodiment, registration is performed via a website hosted by the third party system. In an alternative embodiment, registration is performed at a web panel associated with the web service which the user may navigate directly to or may navigate to via the third party system. In such an embodiment, the third party system may provide a link to the web panel. Note that FIG. 4 illustrates operations performed in the registration process via a website hosted by the third party system but that in the alternative embodiment involving the web panel, FIG. 4 should be viewed as having the third party system replaced by the web panel.

After successfully navigating to the website hosted by the third party system via the user's personal computer, the user selects and enters his or her username and password for the system in step 1200. In an embodiment, the user also enters personal, professional, and/or other information pertinent to registration in step 1200. In an additional embodiment, in step 1200, the user also enters payment information for any fees charged for using the service. Payments may be processed using electronic payment processing such as PayPal or other systems known to those of skill in the art to effectuate credit card payments, electronic check payments, or electronic fund transfers. This registration information is sent from the client computer to the third party system via a network in step 1202. In step 1204, the third party system forwards the registration information to a web service. In step 1206, the web service validates the registration information and stores it in a central database along with an updated user status. In a representative embodiment, only the registration information pertinent to the identification and authentication of a user's identity (i.e., username, password, and other identification information) is stored at the central database. In an embodiment, additional user verification is performed by a logical identification verification provider as known to those of skill in the art. The logical identification verification provider may be any outside service for verifying the identity of a user. The web service returns the registration status to the third party system in step 1208. The third party system forwards the registration status to the client computer in step 1210. In an alternative embodiment, the third party system may direct the user to a website separate from the third party system (such as the web panel). As such, the web panel communicates between the client's computer and the web service instead of the third party system.

In the above described embodiment, registration is performed before a client application has been downloaded to the client computer. As such, the user enters the registration information into a user interface presented via a website by the third party system or at the web panel. In an alternative embodiment, a client application is downloaded from the third party system or the web panel prior to registration.

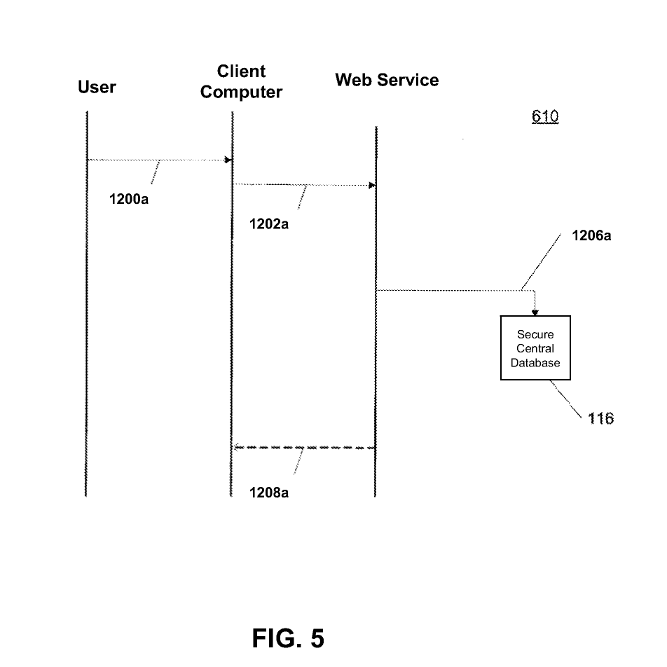

FIG. 5 illustrates user registration at the client application after the client application has been downloaded to the client computer. The user enters the registration information into a user interface presented by the client application at the client computer in step 1200a. The registration information is sent from the client application at the client computer to the web service and/or the third party system in step 1202a. In an embodiment, information identifying a third party system which is associated with the service is sent to the web service. In step 1206a, the web service validates the registration information and stores it in a central database along with an updated user status. The web service returns the registration status to the client application at the client computer in step 1208a.

### Biometric Enrollment

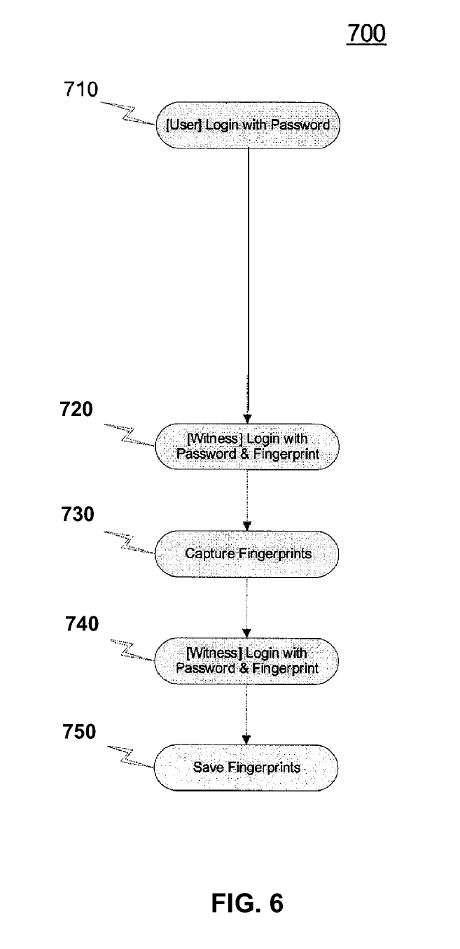

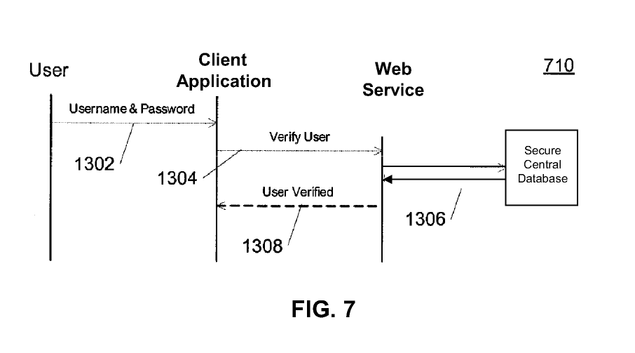

FIG. 6 illustrates operations performed in the user enrollment process in which the user submits his or her biometric data. To begin the user enrollment process 700, in step 710 the user logs in with the username and password as created during the registration process. The details of step 710 are illustrated in FIG. 7. In step 1302 of FIG. 7, the user enters the username and password he or she selected during registration. The client application encrypts the username and password, sends the encrypted information to the web service, and requests the web service to verify the user in step 1304. In step 1306, the server compares the entered username and password to a corresponding previously submitted username and password stored in the central database to verify that the username and password entered is valid. In step 1308, the server returns the status of the user verification to the client application. If the username and password are not successfully verified the user enrollment attempt is deemed invalid and the enrollment process is aborted. In an embodiment, a predefined number of unsuccessful login attempts may lock the system preventing further login attempts.

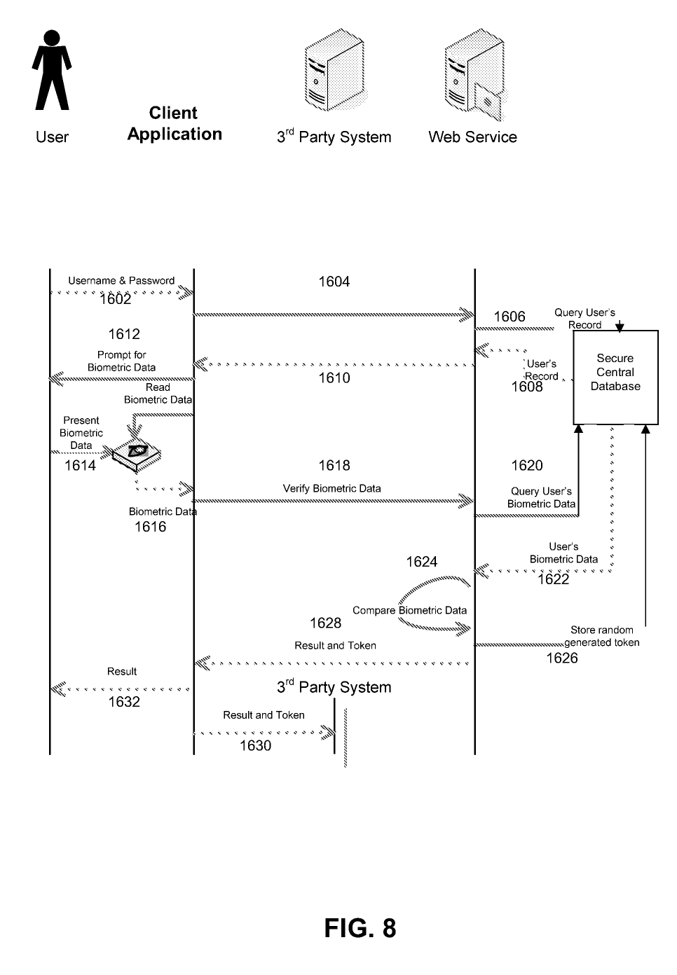

In an embodiment, a registrar is selected and logs in to witness the user's fingerprint enrollment, according to step 720. In an alternative embodiment, the user may not be required to have a registrar witness their fingerprint enrollment, in which case step 720 is skipped. In another embodiment, the third party system determines what type of enrollment is required; i.e., whether a registrar is or is not required, or what type of registrar is required. The details of step 720 are illustrated in FIG. 8. In an operation 1602, the registrar submits his or her username and password in response to a prompt from the client application. The client application requests the web service to validate the username and password of the registrar in an operation 1604. In doing so, the client application encrypts the username and password and forwards the encrypted information to the web service. In an embodiment, a third party system identifier is also sent from the client application to the web service. In operations 1606 and 1608, the web service reads the user's and registrar's account credential information from the central database to verify that the username and password correspond to the registrar and that the registrar is authorized to confirm the user's enrollment. In an embodiment, using the third party system identifier, the web service also determines the login process for the registrar (i.e., whether the biometric login is required). In operation 1610, the web service returns to the client application the registrar's status and possibly an indication that biometric login for is required for the registrar. If the registrar is not authorized, the client application may prompt the user for a different registrar. In an embodiment, if the web service determines that biometric login is not required, operations 1610-1626 are skipped, and the authentication status of the registrar is returned to the client application in operation 1628.

In an operation 1612, if biometric login is required of the registrar, the authentication module prompts the registrar for the registrar's biometric data and requests a biometric peripheral to read the biometric data. In an operation 1614, the biometric peripheral receives the registrar's biometric data. The biometric data is read and forwarded to the authentication module in an operation 1616. In an operation 1618, the authentication module encrypts the biometric data, forwards the encrypted biometric data to the web service, and requests verification of the biometric data from the web service. In response, the web service queries the registrar's stored biometric data from the database in an operation 1620. In an operation 1622, the database returns to the web service the registrar's biometric data that was stored in the database during enrollment of the registrar.

The web service then compares the registrar's stored biometric data from the database with the registrar's presently presented biometric data in an operation 1624. The web service generates a comparison result and a unique, randomly generated token. The token may be encrypted to enhance security. The token is used as an electronic ID to identify specific transactions. In an operation 1626, the token is sent to the database where it is stored. The result and token are also sent to the authentication module of the client application from the web service in an operation 1628. The authentication module also forwards the result and the token to the third party system in an operation 1630. Third party systems may validate the token and the authenticity of the transaction which the token represents by using the web service to compare the token received at the third party system with the corresponding token stored at the database. Alternatively, tokens may be generated during additional transactions throughout the login and other processes in order to enhance the security of the transactions. In an operation 1632, the authentication module then displays the result indicating whether the submitted biometric data was successfully authenticated.

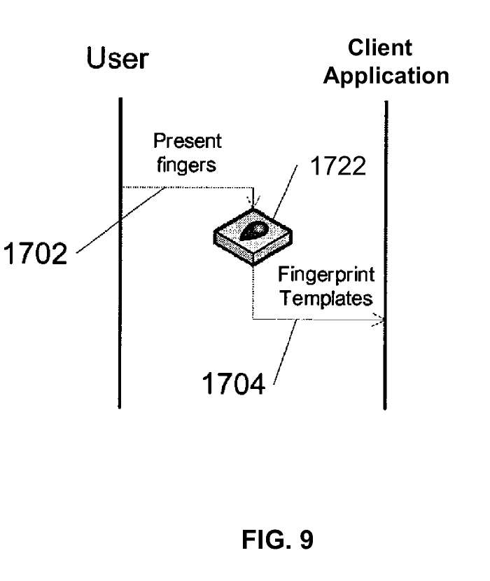

In step 730 of the user enrollment process 700 the user's fingerprints are captured. FIG. 9 illustrates the capture of the user's fingerprints in more detail. In step 1702 of FIG. 9, the user is prompted to place one or more of his or her fingers on a fingerprint sensor 1722, one at a time, so the user's fingerprints can be captured by fingerprint sensor 1722. Fingerprint sensor 1722 sends the user's fingerprint templates to the client application in step 1704. In an alternative embodiment, any type of biometric data may be captured by any other process known by those of skill in the art.

If a registrar is verifying the fingerprint enrollment then the registrar must login with password and biometric information, in step 740 of the user enrollment process 700. The details of step 740 are illustrated in FIG. 8. The registrar can approve the captured fingerprints by successfully logging in. In an embodiment, if the registrar does not login and approve the fingerprints, the captured fingerprints are rejected and the user enrollment process is aborted.

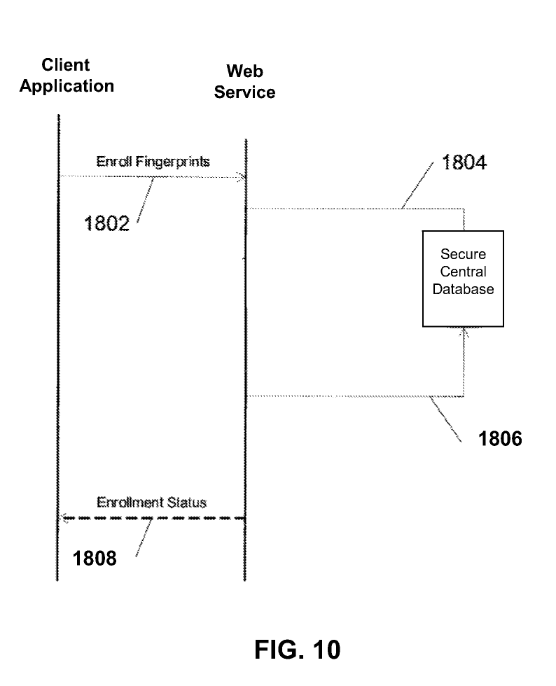

In step 750 of the user enrollment process 700, the user's fingerprint templates are encrypted, forwarded to the web service, and saved to a central database accessible by the web service. FIG. 10 illustrates the details of step 750. In step 1802, the client application sends the captured fingerprint templates and other enrollment information to the web service. In step 1804, the user's record is retrieved from the central database by the web service. The web service modifies the user's record to include the enrolled biometric information of the user and stores the modified user's record in the database in step 1806 The enrollment status is returned to the client application in step 1808.

### Delegate Selection

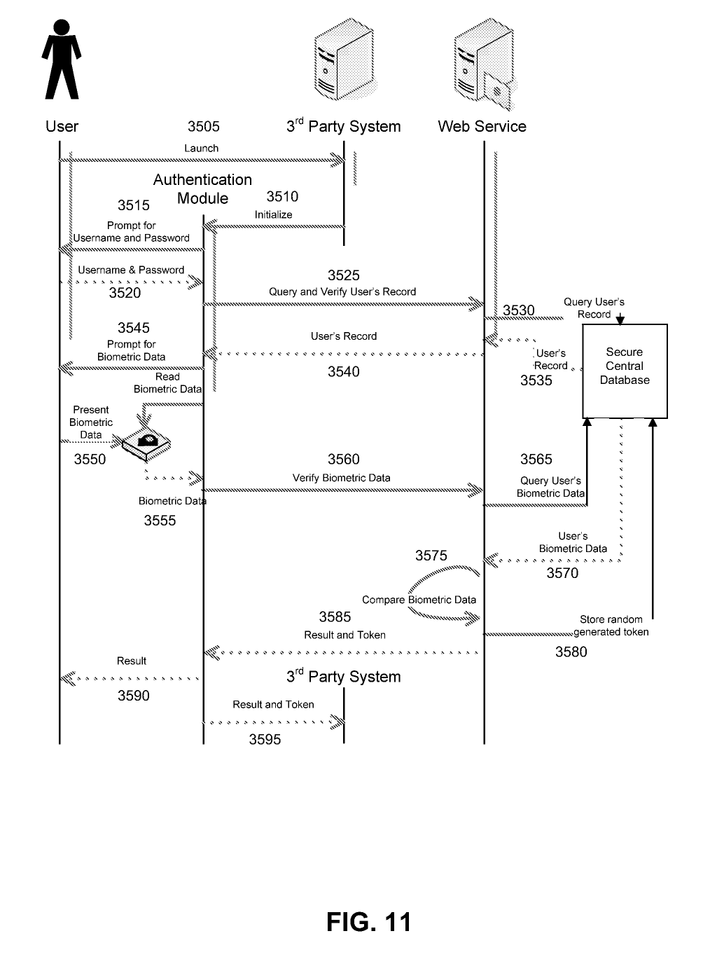

An active user may select a delegate via the web panel. As such, the user grants access to the delegate to sign in and utilize the user's account on the user's behalf. The user may select a delegate by navigating to the web panel and logging in as described below with reference to FIG. 11. The web panel is configured to provide a user interface for adding a delegate to the user's account. The web panel prompts the user for information identifying the delegate. In an embodiment, the delegate selected by the user must already be registered and enrolled as described above. After the user has submitted the delegate's information, the web panel forwards the information to the web service where the delegate's status as a delegate of the user is stored in the central database. In an embodiment, the web service emails a confirmation to the user and/or the delegate upon successful addition of the delegate.

### Registrar Registration And Enrollment

The registrar registration and enrollment processes include similar operations as the registration and enrollment processes. As such, the processes will not be further discussed. In an embodiment, the registrar must be granted an endorsement before becoming an active registrar. A registrar's credentials are verified to ensure that any requirements imposed by a third party system are satisfied. Upon successfully verification of the registrar's credentials, the registrar is issued an endorsement that allows the registrar to perform selected operations prescribed by the endorsement.

### Third Party System Authentication

FIG. 11 illustrates operations performed in a third party system biometric authentication process during login of an enrolled user. Additional, fewer, or different operations may be performed depending on the implementation. In an operation 3505, a biometric authentication process is launched at a third party system. In an embodiment, the user launches the biometric authentication process from a client application downloaded on a personal computer. The client application communicates the launch to the third party system. In an alternative embodiment, the user launches the biometric authentication process directly from a website hosted by the third party system.

The third party system responds by initializing the authentication module in an operation 3510. In an embodiment, a third party system identifier is sent from the third party system to the authentication module of the client application. The third party system identifier uniquely identifies the third party system and may be used to confirm login requirements of the third party system. In an embodiment, the third party system identifier is generated by a web service upon registration of the third party system with the web service.

In an operation 3515, the authentication module prompts the user for a username and password. In an operation 3520, the authentication module receives the user's username and password. In an operation 3525, the authentication module then attempts to verify the username and password by querying the user's record at the web service. In doing so, the client application encrypts the username and password and forwards the encrypted information to the web service. In an embodiment, the client application includes the third party system identifier in the encrypted information. In response, the web service queries the user's record from a database in an operation 3530. In an operation 3535, the database returns the user's record to the web service. In an embodiment, the web service determines the login requirements for the user based on the third party system identifier and account credential information of the user.

In an alternative embodiment, a user may simultaneously utilize multiple third party systems. As such, a third party system identifier is received at the client application from each third party system being utilized. The client application encrypts and forwards the user's username, password, and any other required information along with the respective third party system identifiers to the web service. Using the respective third party system identifiers the web service can verify and enable appropriate login procedures for each respective third party system based on each respective third party system's login requirements and on the user's record.

If the web service determines, based on the third party system identifier and the user's account credential information, that biometric login is not required and that login with username and password is sufficient, operations 3540-3575 are skipped, and the login authentication status of the user is returned to the client application in operation 3585. If biometric login of the user is required, the web service forwards the user's record to the authentication module in an operation 3540. The user's record may include an indication of the type of login required (i.e., an indication that biometric login is required) or information confirming that user is or is not an enrolled user. In an operation 3545, the authentication module prompts the user for the user's biometric data and requests a biometric peripheral to read the biometric data. In an operation 3550, the biometric peripheral receives the user's biometric data. The biometric data is read and forwarded to the authentication module in an operation 3555. In an operation 3560, the authentication module forwards the biometric data to the web service and requests verification of the biometric data from the web service. In response, the web service queries the user's stored biometric data from the database in an operation 3565. In an operation 3570, the database returns to the web service the user's record including biometric data that was stored in the database at enrollment.

In an operation 3575, the web service compares the user's stored biometric data from the database with the user's presently presented biometric data and authenticates the user if the stored and presently presented biometric data matches. The web service generates the comparison result and a unique, randomly generated token. The token may be encrypted to enhance security. The token is used as an electronic ID to identify specific transactions. In an operation 3580, the token is sent to the database where it is stored. The result and token are also sent to the authentication module from the web service in an operation 3585. The authentication module also forwards the result and the token to the third party system in an operation 3595. Third party systems may validate the token and the authenticity of the transaction which the token represents by using the web service to compare the token received at the third party system with the corresponding token stored at the database. In this way, a more secure transaction environment is provided to users and malicious attempts to gain access to third party systems may be better prevented. Alternatively, tokens may be generated during additional transactions throughout the login and other processes in order to enhance the security of the transactions. In an operation 3590, the authentication module then displays the result to the user. The third party system then interprets the received result and responds accordingly.

### User Roles

### User

The user is registered as the main user of the secured account or application at the client application. The user may designate delegates who may access the user's accounts or secured applications.

### Delegate

The delegate is a person, trusted and authorized by a user to access secured accounts or applications on the user's behalf. The concept of the delegate allows the work of the user to be performed by a substitute when the user is not present. The fact that an account or application was accessed by a delegate may be recorded in the secure central database and reviewed by the user.

### Registrar

The registrar is actually a user that may function in the role of a witness during biometric enrollment for potential certified users. The registrar is responsible for verifying the potential user's identity, and then verifying that the user submits only his or her own biometric samples (fingerprints) to the system according to the established enrollment process. The biometric information is critical in verifying the identity of a user, the enrollment process must be witnessed and certified by the registrar, and the identity of the certifying registrar may be saved in the enrollee's record in the central database.

### Security

It is anticipated that the embodiment described will be subjected to attacks by persons or groups. The attacks may be intended to break into the secured accounts or applications for the purpose of committing fraud, theft, or other offenses. Other possible attacks could be the attempt to impersonate a legitimate user and provide falsified information which appear to be the work of the legitimate user, but are not.

The architecture of the embodiment described has been carefully designed to make the system resistant to attacks on the technology and the processes. The embodiment described provides multiple layers of security in all sensitive areas. The processes and procedures which have been defined for installation, registration, enrollment and activation help ensure that biometric identification credentials of users of the present invention cannot be falsified. These processes and procedures work together with layers of software security technology to ensure the integrity of the information being protected. The software technology used to implement the layers of protection include secure communication between the client applications and the web service, layered encryption, proprietary encryption key management, insertion of blocks of seemingly random data, information obfuscation, digital signature generation, and encryption based application security.

### Secure Communication Between Client Computer And Server

The embodiment described incorporates a distributed processing architecture which divides processing tasks between the user's PC and secure web servers. The client application performs processing, encrypts partial results, and passes the encrypted information to the server, where processing continues. The results of the processing performed on the server are encrypted and returned to the client application at the client computer, where processing may continue.

All sensitive information is encrypted before being passed between the client application and the server. The keys used to encrypt the sensitive information for communication between the client application and the server are changed frequently during processing.

### Layered Encryption

The embodiment described uses modem, industry standard encryption technology to protect the information being transferred. The system uses several proprietary enhancements to the encryption technology to provide a higher level of security to transferred information such as user information and biometric data. One of the techniques used in the protection scheme is that of layered encryption.

### Blocks of Seemingly Random Data

The embodiment described incorporates the use of blocks of seemingly random data to increase the level of difficulty encountered by a potential attacker when trying to defeat the protection schemes used by the system. Theses blocks are used as one of the inputs to the cryptographic algorithms. The inclusion of these blocks aid in preventing any recognizable patterns which could provide clues to an attacker about the operation of the present invention. The present invention uses this technique in many of the sensitive areas.

### Obfuscation

Obfuscation, or the generation of hash values from data, is used to enhance security and conceal information during processing at both the client computer and the server. The embodiment described performs obfuscation of sensitive information in the client application and in the server, and processes the obfuscated values and other information to determine processing results.

### Application Security

The client application cannot be started directly. Additional encrypted information must be provided in order to startup and execute the application correctly. The purpose of this requirement is to enhance the security of the application. An attempt to bypass portions of the application will result in an unrecoverable error, preventing the attacker from successfully running the application using this strategy.

It is important to understand that any of the embodiments described herein may be implemented as computer-readable instructions stored on a computer-readable medium. Upon execution by a processor, the computer-readable instructions can cause a computing device to perform operations to implement any of the embodiments described herein.

While the invention has been described in what is presently considered to be a preferred embodiment, it should be understood that this is done for illustration purposes only. A person skilled in the relevant art will recognize that other components and configurations may be used without parting from the spirit and scope of the appended claims. In addition, with respect to any processes or methods described herein, additional, fewer, or different operations may be performed depending on the implementation.

What is claimed is:

1. A method for authenticating an identity of a user, the method comprising:
receiving biometric data of a user from a user interface at a server, wherein the user interface is associated with a third party system;
comparing the received biometric data to stored biometric information, wherein the stored biometric information is stored in a secure database, and wherein the stored biometric information was previously obtained from the user during an enrollment process;
generating a comparison result at the server, wherein the comparison result documents if the stored biometric information is satisfied; and
communicating the comparison result from the server to the third party system, wherein the third party system is configured to utilize the comparison result to authenticate an identity of the user.

2. The method of claim 1, further comprising receiving, at the server, account credential information submitted by the user.

3. The method of claim 2, wherein the user interface is further configured to receive login information and the biometric data.

4. The method of claim 2, wherein the account credential information comprises a username and a password of the user.

5. The method of claim 4, further comprising requesting a record of the user from the secure database in response to the receiving the account credential information.

6. The method of claim 5, further comprising receiving the requested record from the database.

7. The method of claim 6, further comprising communicating a status of the user to the user interface, wherein the status of the user is generated from the requested record.

8. The method of claim 1, wherein the received biometric data is encrypted, and further comprising decrypting the encrypted received biometric data at the server.

9. The method of claim 1, further comprising generating a transaction ID, wherein the transaction ID identifies the comparing the stored biometric information to the biometric data, wherein the transaction ID is configured to allow the third party system to authenticate the comparison result.

10. The method of claim 9, further comprising storing the transaction ID in the secure database and providing the transaction ID to the third party system.

11. The method of claim 1, further comprising providing the comparison result to the user interface, wherein the comparison result is to be displayed at the user interface.

12. The method of claim 1, further comprising receiving registration information of the user from the user interface, wherein the registration information includes personal, professional, or license information of the user.

13. The method of claim 1, further comprising:
receiving enrollment biometric data of the user during an enrollment process; and
storing the enrollment biometric data at the secure database.

14. The method of claim 1, further comprising:
receiving information identifying the third party system;
determining login requirements for the user based at least in part on the information identifying the third party system.

15. A method for authenticating an identity of a user, the method comprising:
receiving biometric data of a user at a user interface;
communicating the received biometric data from the user interface to a server, wherein the received biometric data is compared to stored biometric information, wherein the stored biometric information is stored in a database, and wherein the stored biometric information was previously obtained from the user during an enrollment process;
receiving a comparison result generated at the server, wherein the comparison result documents if the stored biometric information corresponds to the received biometric data; and
communicating the comparison result to the third party system, wherein the third party system is configured to utilize the comparison result to authenticate an identity of the user.

16. The method of claim 15, further comprising receiving account credential information of a user at the user interface.

17. The method of claim 16, wherein the account credential information comprises a username and a password of the user.

18. The method of claim 17, further comprising receiving an indication of a login requirement for the user from the server, wherein the indication of the login requirement was determined by the server.

19. The method of claim 18, further comprising displaying a request for submission of the biometric data from the user.

20. The method of claim 15, further comprising receiving a transaction ID that identifies a comparison of the received biometric data to the stored biometric information by the server, wherein the transaction ID is generated by the server, and wherein the transaction ID is configured to allow the third party system to authenticate the comparison result.

21. The method of claim 20, further comprising communicating the transaction ID to the third party system.

22. The method of claim 15, further comprising displaying the comparison result.

23. The method of claim 15, further comprising receiving registration information of the user at the user interface, wherein the registration information includes personal, professional, or license information of the user.

24. The method of claim 15, wherein the user interface is downloaded to a client computer from the third party system or from a web site associated with the server.

25. The method of claim 15, further comprising receiving information identifying the third party system from the third party system and sending the information identifying the third party system to the server.

26. An identity authentication system comprising:
a server configured to communicate with a plurality of computers coupled to a network, wherein each of the plurality of computers comprises a user interface configured to receive biometric data from a user;
a secure database coupled to the server and storing user information, wherein the user information includes stored biometric information of the user; and
a third party system configured to communicate with the server and with the plurality of computers; and
wherein the server is configured to:
compare the received biometric data to the stored biometric information;
generate a comparison result; and
provide the comparison result to the third party system.

27. The system of claim 26, wherein the user interface is further configured to receive account credential information of the user, wherein the server is configured to request a record of the user corresponding to the account credential information, and wherein the requested record is stored in the secure database.

28. The system of claim 27, wherein the account credential information comprises a username and a password of the user.

29. The system of claim 28, wherein the server is configured to provide information indicating a login requirement of the user to the user interface.

30. The system of claim 26, wherein the user interface is configured to encrypt the received biometric data for communication to the server.

31. The system of claim 26, wherein the server is further configured to generate a transaction ID that identifies the comparing the received biometric data to the stored biometric information, and wherein the transaction ID is configured to allow the third party system to authenticate the comparison result.

32. The system of claim 31, wherein the database is configured to store the transaction ID, and wherein the server is configured to provide the transaction ID to the user interface.

33. The system of claim 32, wherein the user interface is configured to provide the transaction ID to the third party system.

34. The system of claim 26, wherein the server is configured to provide the comparison result to the user interface.

35. The system of claim 26, wherein the user interface is configured to receive registration information of the user, and wherein the registration information includes personal, professional, or license information of the user.

36. The system of claim 35, wherein the user interface is further configured to receive enrollment biometric data of the user during an enrollment process and communicate the enrollment biometric data to the server, and wherein the sever is configured to store the enrollment biometric data as the stored biometric information of the user at the secure database.

37. The system of claim 36, wherein the user interface is configured to allow a registrar previously enrolled and authorized to biometrically log in to initiate and approve an enrollment process for a new user.

38. The system of claim 26, wherein the third party system is configured to provide the user interface at each of the plurality of computers.

39. An identity authentication system comprising:
a server coupled to a database, wherein the database is configured to store user information that includes stored biometric information of a user, wherein the server is in communication with a third party system and a plurality of computers coupled to a network, and wherein each of the plurality of computers comprises a user interface configured to receive biometric data of the user; and
wherein the server is configured to:
compare the received biometric data to the stored biometric information;
generate a comparison result; and
provide the comparison result to the third party system, wherein the third party system is configured to utilize the comparison result to authenticate an identity of the user.
